(19) United States
(12) Patent Application Publication
(10) Pub. No.: US 2026/0288040 A1
(43) Pub. Date: Sep. 24, 2026

(54) IMAGE FORMING APPARATUS, CONTROL METHOD OF IMAGE FORMING APPARATUS, AND NON-TRANSITORY COMPUTER-READABLE RECORDING MEDIUM STORING CONTROL PROGRAM FOR IMAGE FORMING APPARATUS

(71) Applicant: Konica Minolta, Inc., Tokyo (JP)

(72) Inventor: Kenichi Hosoi, Saitama (JP)

(73) Assignee: Konica Minolta, Inc., Tokyo (JP)

(21) Appl. No.: 19/572,224

(22) Filed: Mar. 19, 2026

(30) Foreign Application Priority Data
Mar. 21, 2025 (JP) 2025-047030

(51) Int. Cl. G03G 15/00; G03G 15/01; G03G 15/20

(52) U.S. Cl. CPC G03G 15/5029; G03G 15/0131; G03G 15/0189; G03G 15/2028; G03G 15/2064; G03G 15/6558; G03G 15/6594; G03G 2215/00599; G03G 2215/00603; G03G 2215/00717

(57) ABSTRACT

An image forming apparatus includes: a sheet feeder that feeds a sheet; a conveyor that conveys the sheet along a conveyance route; an image former that is disposed in the conveyance route and forms an image on the sheet; a reader that is disposed on an upstream side of the image former for photographing in a conveyance direction and captures an image of the sheet; and a controller that adjusts, based on an arrangement aspect of a punch hole in the sheet, setting related to conveyance processing of the sheet, where the arrangement aspect is detected from a read image.

### CROSS REFERENCE TO RELATED APPLICATIONS

The entire disclosure of Japanese Patent Application No. 2025-47030, filed on Mar. 21, 2025, is incorporated herein by reference in its entirety.

### BACKGROUND

### Technological Field

The present disclosure relates to an image forming apparatus, a control method of an image forming apparatus, and a non-transitory computer-readable recording medium storing a control program for an image forming apparatus.

### Description of Related Art

In the related art, there are known image forming apparatuses such as a copier and a printer. In recent years, as this type of image forming apparatus, an image forming apparatus has been developed in which a post-processing unit is coupled to an image forming unit and which is capable of performing ring binding processing on a sheet, on which printing has been performed by the image forming apparatus, to bind a booklet or the like. For example, see Japanese Patent Application Laid-Open No. 2013-152314.

Incidentally, in the related art, this type of image forming apparatus has adopted a configuration in which a normal sheet (which means a sheet without any punch hole; the same applies hereinafter) is fed from a sheet fed unit and a punch hole is formed at the stage of the post-processing unit. At the actual site of use, however, there is a demand to use a binder sheet (also referred to as a pre-punched sheet), in which a punch hole has been formed in advance, for printing for reasons for wishing to use a special sheet, to adopt a unique printing process, and the like.

However, in this type of image forming apparatus, a conveyance unit for a sheet is controlled according to a sheet standard set in advance such that no conveyance failure occurs even at the time of high-speed printing. For this reason, when printing is performed using a binder sheet in which a punch hole has been formed in advance, the conveyance unit needs to be adjusted in line with the binder sheet.

For example, in this type of image forming apparatus, a conveyance sensor (for example, a photo sensor) for detecting that a sheet has passed through a predetermined position is disposed in a conveyance route. Then, a controller performs, based on the passing timing of the sheet detected by the conveyance sensor, synchronous control of the conveyance operation and the image forming operation or performs control such that the conveyance timing of the subsequent sheet is adjusted. For this reason, in a case where a binder sheet is used in an image forming apparatus of this type, the controller may erroneously detect a punch hole of the sheet as the passing timing of the sheet and cause a conveyance failure such as a sheet jam.

Note that, Japanese Patent Application Laid-Open No. H10-315553 proposes, as processing in a case where a binder sheet is used, a method in which the user performs use setting of a binder sheet on a system in advance and sets a mask for erroneous detection prevention for a sensor signal of the conveyance sensor. In this method, however, in a case where the use setting of the binder sheet is not appropriately performed on the system, a mask is not accurately applied, which causes a conveyance failure. In addition, a conveyance failure is also caused in the same manner in a case where an actual setting direction of a sheet is different from a defined setting direction on a sheet feed tray.

In addition, apart from those mentioned above, a binder sheet may cause various conveyance failures in an image formation apparatus, for example, a curl state (for example, curling of the leading end side) is likely to occur during conveyance, or a slip of a conveyance roller is likely to occur at a punch hole position.

In this regard, since there are a considerable number of binder sheet specifications, there are cases where the user side performs erroneous sheet use setting on a system due to an erroneous recognition by the user, or the like. In addition, at the actual site of use, there are also cases where only printing is performed on a binder sheet, and it is cumbersome for the user to change the sheet use setting each time.

### SUMMARY

The present invention has been made in view of the above-mentioned problems. That is, it is an object of the present invention to provide an image forming apparatus, a control method of an image forming apparatus, and a non-transitory computer-readable recording medium storing a control program for an image forming apparatus, each of which is capable of suppressing the occurrence of a conveyance failure when printing is performed using a binder sheet.

To achieve at least one of the above-mentioned objects, according to an aspect of the present invention, an image forming apparatus reflecting one aspect of the present invention is applicable to a binder sheet and includes:

a sheet feeder that feeds a sheet;

a conveyor that conveys the sheet along a conveyance route;

an image former that is disposed in the conveyance route and forms an image on the sheet;

a reader that is disposed on an upstream side of the image former in a conveyance direction and captures an image of the sheet; and

a hardware processor that adjusts, based on an arrangement aspect of a punch hole in the sheet, setting related to conveyance processing of the sheet, where the arrangement aspect is detected from a read image.

In addition, a control method of an image forming apparatus reflecting another aspect of the present invention is a control method of an image forming apparatus applicable to a binder sheet and includes:

feeding a sheet;

conveying the sheet along a conveyance route;

capturing an image of the sheet to be conveyed;

forming an image on the sheet to be conveyed; and

adjusting, based on an arrangement aspect of a punch hole in the sheet, setting related to conveyance processing of the sheet, where the arrangement aspect is detected from a read image.

In addition, a control method of an image forming apparatus storing a control program for an image forming apparatus reflecting another aspect of the present invention is a non-transitory computer-readable storage medium storing a control program for an image forming apparatus applicable to a binder sheet and the control program causes a computer to execute:

feeding a sheet;

conveying the sheet along a conveyance route;

capturing an image of the sheet to be conveyed;

forming an image on the sheet to be conveyed; and

adjusting, based on an arrangement aspect of a punch hole in the sheet, setting related to conveyance processing of the sheet, where the arrangement aspect is detected from a read image.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating an example of the overall configuration of an image forming apparatus according to an embodiment of the present invention;

FIGS. 2A, 2B, and 2C are diagrams each of which illustrates an example of a binder sheet;

FIG. 3 is a diagram illustrating an example of the configuration of a control system of the image forming apparatus according to an embodiment of the present invention;

FIG. 4 is a diagram provided for describing processing of adjusting a setting range of a mask for erroneous detection prevention;

FIG. 5 is a diagram provided for describing processing of adjusting an acceleration start timing of a sheet;

FIG. 6 is a diagram provided for describing processing of adjusting a sheet loop amount;

FIG. 7 is a diagram provided for describing processing of adjusting a separation bias to be applied to a sheet separator;

FIG. 8 is a diagram provided for describing processing of adjusting a transfer bias to be applied to a secondary transfer section;

FIG. 9 is a diagram provided for describing processing of adjusting an air volume of a fixing separation fan;

FIG. 10 is a flowchart illustrating exemplary operations of a controller according to an embodiment of the present invention; and

FIG. 11 is a flowchart illustrating exemplary operations of the controller according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

### Overall configuration of image forming apparatus

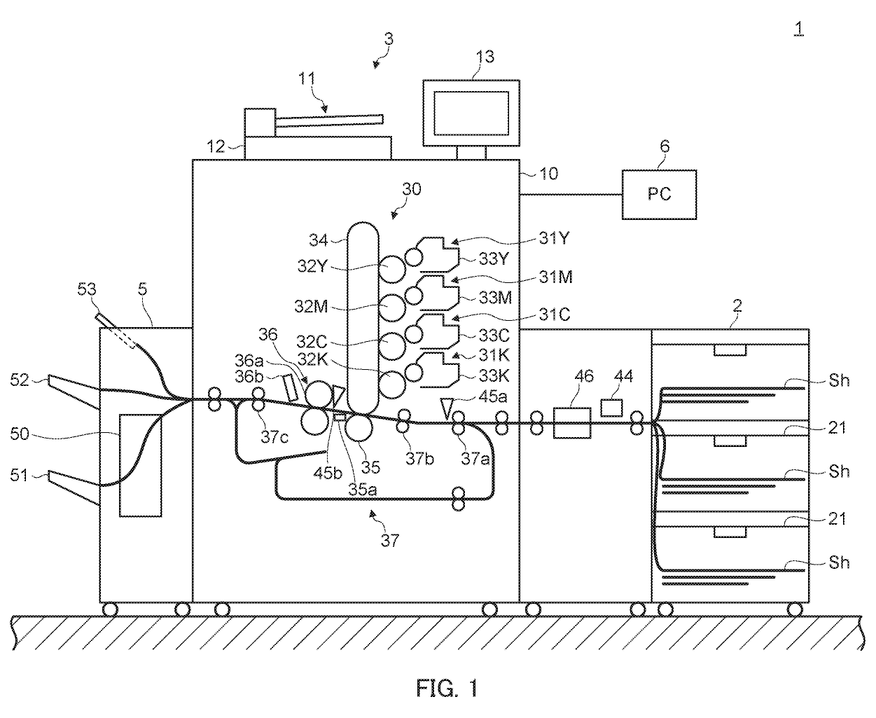

First, an example of the configuration of an image forming apparatus (hereinafter, referred to as the “image forming apparatus 1”) according to an embodiment of the present invention will be described with reference to FIG. 1.

FIG. 1 is a schematic diagram illustrating an example of the overall configuration of the image forming apparatus 1.

The image forming apparatus 1 includes a sheet feed unit 2, an image forming unit 3, and a post-processing unit 5. The sheet feed unit 2, the image forming unit 3, and the post-processing unit 5 are connected by a conveyor 37.

The sheet feed unit 2 includes sheet feed trays 21 of three stages and feeds a sheet Sh from one of the sheet feed trays 21. The sheet feed trays 21 are containers each of which accommodates the sheet Sh on which image formation is performed by an image former 30. A sheet set in the sheet feed trays 21 is fed to the image forming unit 3 by, for example, a pickup roller (not illustrated). Note that, the sheet feed unit 2 corresponds to the “sheet feeder” in the present invention.

In the sheet feed tray 21, for example, a normal sheet and/or a binder sheet in which a punch hole has been formed in advance are loaded. The sheets in the three sheet feed trays 21 may be of the same type or of different types.

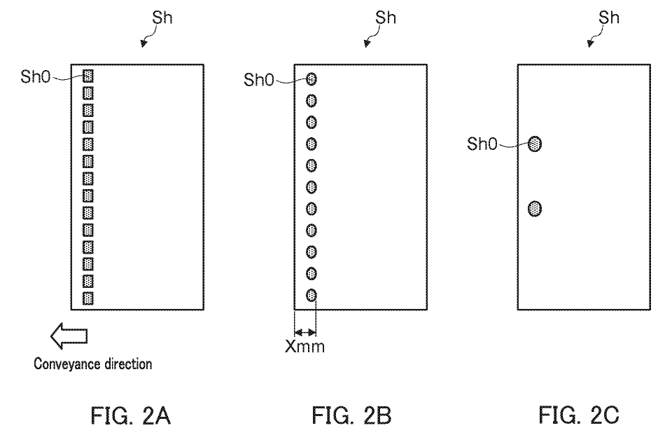

FIGS. 2A, 2B, and 2C are diagrams each of which illustrates an example of a binder sheet Sh. The binder sheet Sh includes a punch hole Sh0 through which a ring binding member is passed. FIGS. 2A, 2B, and 2C illustrate three types of binder sheets different in the arrangement or size of the punch hole Sh0.

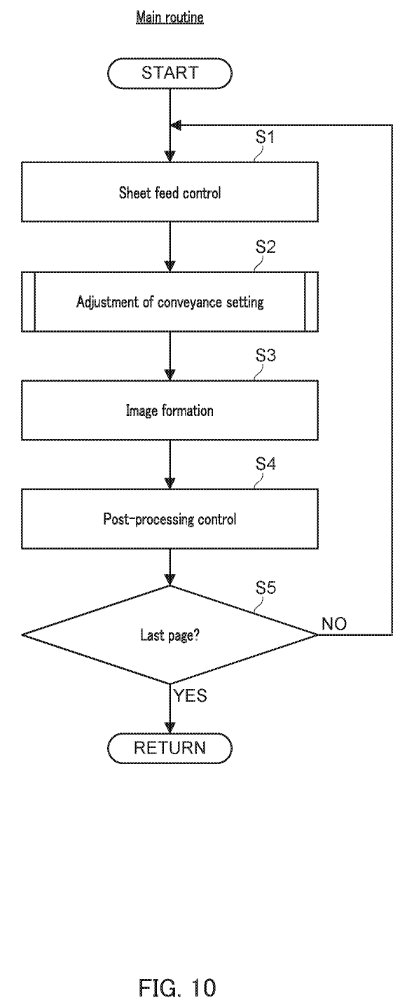

In the image forming apparatus 1 according to the present embodiment, the arrangement aspect of the punch hole Sh0 is detected based on an image obtained when a reader 44 captures an image of a sheet (hereinafter, this image data will be referred to as a “read image”) (this matter will be described later with reference to FIG. 10). Note that, hereinafter, an aspect will be indicated, as illustrated in FIG. 2, in which the binder sheet Sh is set in the sheet feed tray 21 so as to be conveyed toward the left side of the paper surface (the side of the sheet Sh, on which the punch hole Sh0 is formed). Here, the punch hole Sh0 is disposed at a position of X mm from the leading end of the binder sheet Sh in the conveyance direction.

The image forming unit 3 forms an image on the sheet Sh by an electrophotographic method. The image forming unit 3 forms, for example, a color image on the sheet Sh in a tandem form in which toner images of four colors of yellow (Y), magenta (M), cyan (C), and black (K) are superposed. The image forming unit 3 is connected to a PC 6 that is operated by an operator via a LAN (not illustrated). Then, the image forming unit 3 performs various pieces of processing, such as image formation processing, according to a job submitted from the PC 6 via the LAN.

The post-processing unit 5 performs predetermined post-processing (also referred to as finisher processing) on the sheet Sh on which an image has been properly formed by the image forming unit 3. The post-processing unit 5 includes, for example, as a post-processing section 50, a ring binding section that performs a series of processing, such as loading a predetermined number of sheets Sh on a stack section, attaching a ring binding member to a bundle of the sheets loaded on the stack section, and binding the sheets. For details of the configuration of the ring binding section, see, for example, Japanese Patent Application Laid-Open No. 2013-152314.

A first sheet ejection tray 51, a second sheet ejection tray 52, and a purge tray 53 are connected to the post-processing unit 5. The sheet Sh subjected to the post-processing is ejected to the first sheet ejection tray 51. The sheet Sh that does not require the post-processing is ejected to the second sheet ejection tray 52. In addition, the sheet Sh determined as an incorrect sheet is ejected to the purge tray 53.

Here, an example of the configuration of the image forming unit 3 will be described.

The image forming unit 3 includes an image input section 11, an operation display section 13, the image former 30, a fixing section 36, and the conveyor 37.

The image input section 11 optically reads an image from a document on a document plate 12, and performs A/D conversion on the read image to generate image data (scan data).

The operation display section 13 is constituted by a display section composed of a liquid crystal panel or the like, and an operation section composed of a touch sensor or the like. The display section and the operation section are integrally formed as a touch screen, for example. The operator checks a dialog or a screen displayed on the operation display section 13. Accordingly, the operation display section 13 is used as a display section that displays information for notifying the operator that the resumption of the execution of a job has been stopped. In addition, the operation display section 13 is also used as an input section through which the operator inputs an instruction to interrupt or execute a job.

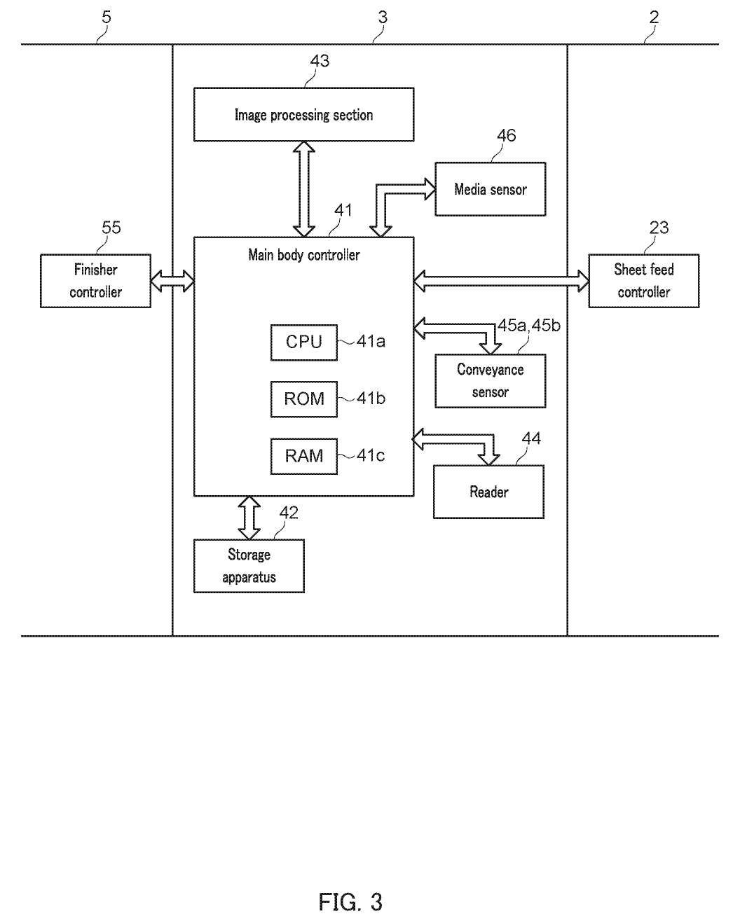

The operation display section 13 generates an operation signal indicating details of an operation inputted by the operator, and supplies the operation signal to a main body controller 41 (see FIG. 3 to be described later). In addition, the operation display section 13 displays the content of an operation of the operator, setting information, and the like, based on a display signal supplied from the main body controller 41.

The conveyor 37 conveys the sheet Sh, which has been fed from the sheet feed unit 2, along a conveyance route. Specifically, the conveyor 37 first conveys the sheet Sh from the sheet feed tray 21 to the image former 30. Next, the conveyor 37 conveys the sheet Sh from the image former 30 to the post-processing unit 5. Next, the conveyor 37 conveys the sheet Sh from the post-processing unit 5 to the first sheet ejection tray 51, the second sheet ejection tray 52, or the purge tray 53.

The conveyor 37 is constituted by, for example, a conveyance belt, conveyance rollers, motors (not illustrated) that drive the conveyance rollers, a rotating member (not illustrated) for turning over the sheet Sh on which printing has been performed on only one side when double-sided printing is performed, a conveyance sensor, and the like.

More specifically, the conveyor 37 includes a loop roller pair 37a, a registration roller pair 37b, and a variable speed roller pair 37c as conveyance rollers disposed in the conveyance route. The loop roller pair 37a, the registration roller pair 37b, and the variable speed roller pair 37c are conveyance roller pairs that form a nip section by being pressed against each other. Note that, motors are connected to the conveyance roller pairs 37a, 37b, and 37c, respectively, and the conveyance roller pairs 37a, 37b, and 37c are separately controlled by the main body controller 41.

The loop roller pair 37a and the registration roller pair 37b are arranged side by side on the upstream side of the image former 30, for example. The loop roller pair 37a and the registration roller pair 37b cooperate to function as a bend correction mechanism. In addition, the registration roller pair 37b adjusts the conveyance timing of the sheet Sh to align an image (toner image) formed on an intermediate transfer belt 34 of the image former 30 with the sheet Sh.

The registration roller pair 37b temporarily stops rotating when a bend correction is performed on the sheet Sh. Thereafter, the leading end of the sheet Sh is abutted against the nip section formed by the registration roller pair 37b. In this state, the loop roller pair 37a on the upstream side is rotationally driven, and a loop is formed in the sheet Sh between the registration roller pair 37b and the loop roller pair 37a. When the loop is formed, the leading end of the sheet Sh becomes parallel to the axis direction of the registration roller pair 37b. After the bending of the leading end of the sheet Sh is corrected in this manner, the registration roller pair 37b is rotationally driven. Thus, the sheet Sh is conveyed to a transfer position (a position where a toner image is transferred onto the sheet Sh from an intermediate transfer belt to be described later) in the image former 30 while the inclination and distortion of the entire sheet Sh are corrected.

The variable speed roller pair 37c is disposed, for example, immediately downstream of the fixing roller pair 36a of the fixing section 36. The variable speed roller pair 37c changes the conveyance speed of the sheet Sh with the intention of gaining processing time at the post-processing section 50 and in the fixing processing. For example, the variable speed roller pair 37c decreases the conveyance speed of the sheet Sh while the sheet Sh is passing through the fixing section 36, and increases the conveyance speed of the sheet Sh by acceleration until the sheet Sh reaches the post-processing section 50 after passing through the fixing section 36.

The image former 30 includes four toner image forming units 31Y, 31M, 31C, and 31K for forming toner images in respective colors of Y, M, C, and K, and forms an image on the sheet Sh based on a job. The toner image forming units 31Y, 31M, 31C, and 31K include charging sections and exposure sections (both of which are not illustrated), photoreceptor drums 32Y, 32M, 32C, and 32K as image carriers, and developing sections 33Y, 33M, 33C, and 33K, respectively.

The developing sections 33Y,33M,33C, and 33K emit light to the respective surfaces (outer peripheries) of the photoreceptor drums 32Y, 32M, 32C, and 32K according to images, thereby forming electrostatic latent images on the circumferences of the photoreceptor drums. Then, the developing sections 33Y,33M,33C, and 33K develop toner images on the photoreceptor drums 32Y, 32M, 32C, and 32K by causing the toners to adhere to the electrostatic latent images.

In addition, the image former 30 includes the intermediate transfer belt 34 and a secondary transfer section 35. The intermediate transfer belt 34 is a belt onto which toner images formed on the photoreceptor drums 32Y, 32M, 32C, and 32K are primarily transferred.

The secondary transfer section 35 is, for example, a transfer roller that secondarily transfers toner images in the respective colors, which have been primarily transferred onto the intermediate transfer belt 34, onto the sheet Sh that has been conveyed through the conveyor 37. The secondary transfer section 35 transfers the toner image formed on the intermediate transfer belt 34 onto the sheet Sh by applying a bias having a polarity opposite to that of the toner (hereinafter, referred to as a transfer bias) to the transfer roller.

In addition, a sheet separator 35a is provided immediately downstream of the transfer roller of the secondary transfer section 35 (that is, in the vicinity of the conveyance route after transfer). The sheet separator 35a is constituted by, for example, a discharging member for separating the sheet Sh from the transfer roller. The sheet Sh after the toner image is transferred is in a state of being charged by the transfer bias. The sheet separator 35a applies, for example, a bias having a polarity opposite to that of the transfer bias to the sheet Sh to facilitate the separation of the sheet Sh from the transfer roller.

The fixing section 36 is disposed on the downstream side of the secondary transfer section 35 along the sheet conveyance direction and performs fixing processing on the sheet Sh which is supplied from the image former 30 and on which a color toner image has been formed. The fixing section 36 heats and pressurizes the sheet Sh, which has been conveyed, to fix the toner image, which has been transferred by the image former 30, on the front surface side of the sheet Sh. The image thus formed on the sheet Sh is fixed, and thus, the printing is completed.

The fixing section 36 is constituted by, for example, a fixing roller pair 36a that is a pair of fixing members. The fixing roller pair 36a is disposed in a state in which an upper fixing roller and a lower fixing roller are in pressure contact with each other, and a fixing nip section is formed as a pressure contact section between the upper fixing roller and the lower fixing roller.

A heating section (for example, a halogen heater) is provided inside the fixing upper roller. A roller section of the upper fixing roller is warmed by radiation heat from the heating section. Then, the heat of the roller section of the fixing upper roller is transmitted to the sheet Sh, whereby the toner image on the sheet Sh is thermally fixed.

The sheet Sh is conveyed such that the surface onto which the toner image has been transferred by the secondary transfer section 35 (fixing target surface) faces the fixing upper roller, and passes through the fixing nip section. Accordingly, the sheet Sh is pressurized and heated by the fixing roller pair 36a.

In addition, the fixing section 36 includes a fixing separation fan 36b on the downstream side of the fixing roller pair 36a in the conveyance direction. At the fixing section 36, the sheet Sh after the toner fixing may cause a jam by adhering to and being wound around the upper fixing roller of the fixing roller pair 36a after the sheet Sh after the toner fixing is ejected from the nip section of the fixing roller pair 36a. For this reason, in the fixing section 36 according to the present embodiment, the fixing separation fan 36b is disposed in the vicinity of the exit side of the fixing roller pair 36a and air is blown from above to the sheet Sh that has passed through the fixing roller pair 36a in order to ensure the separation of the sheet Sh from the upper fixing roller of the fixing roller pair 36a.

The sheet Sh on which an image has been fixed by the fixing section 36 is conveyed to the post-processing unit 5 by the conveyor 37. The post-processing section 50 of the post-processing unit 5 performs various pieces of post-processing on the sheet Sh on which an image has been formed. For example, the post-processing section 50 performs ring binding processing on the sheet Sh.

However, apart from the operations described above, the post-processing section 50 may also be configured to be able to execute an operation of folding the sheet Sh, an operation of performing perforation of the sheet Sh, an operation of pasting the sheet Sh, an operation of cutting the sheet Sh, and the like. The sheet Sh that has been post-processed as described above is ejected to one of the first sheet ejection tray 51, the second sheet ejection tray 52, and the purge tray 53 by the conveyor 37.

### Example of configuration of control system of the image forming apparatus 1

FIG. 3 is a diagram illustrating an example of the configuration of a control system of the image forming apparatus 1.

The sheet feed unit 2 includes a sheet feed controller 23 that feeds the sheet Sh, which is stored in the sheet feed tray 21, to the image forming unit 3. The sheet feed controller 23 performs a sheet feed operation by the control of the main body controller 41 included in the image forming unit 3.

The post-processing unit 5 includes a finisher controller 55. The finisher controller 55 controls various types of post-processing (finisher processing) performed at the post-processing section 50. The finisher controller 55 performs a post-processing operation by the control of the main body controller 41 included in the image forming unit 3.

The image forming unit 3 includes the main body controller 41, a storage apparatus 42, an image processing section 43, the reader 44, conveyance sensors 45a and 45b, and a media sensor 46.

The main body controller 41 communicates with each section of the image forming apparatus 1 and comprehensively controls each section of the image forming apparatus 1. The main body controller 41 controls, for example, a sheet feed operation of the sheet feed unit 2, a post-processing operation of the post-processing unit 5, a toner image forming operation of the image former 30, a conveyance operation of the conveyor 37, and the like.

The main body controller 41 is, for example, a microcomputer configured to include a CPU 41a, a ROM 41b, and a RAM 41c. The CPU 41a reads, from the ROM 41b, a program code of a control program that implements each function according to the present embodiment, loads the program code into the RAM 41c, and executes various types of control according to the present embodiment. The ROM 41b accommodates a control program read by the CPU 41a. Further, in addition to the OS and various parameters, a program for causing the main body controller 41 to function is recorded in the ROM 41b. The RAM 41c is used to temporarily store data for executing the control program. In the RAM 41c, variables, parameters, and the like generated during arithmetic processing of the CPU 41a are temporarily written, and these variables, parameters, and the like are read as appropriate by the CPU 41a.

Note that, hereinafter, the main body controller 41 will be simply referred to as the “controller 41”.

The storage apparatus 42 is an example of a non-volatile storage, and stores various types of data and program data that are outputted from the main body controller 41. As the storage apparatus 42, for example, an HDD, an SSD, a non-volatile memory, or the like is used.

Under the control of the controller 41, the image processing section 43 performs image processing on the image data transferred from the PC 6, and stores the obtained image data in the storage apparatus 42. Examples of the image processing performed by the image processing section 43 include raster image processor (RIP) processing, correction processing, color conversion processing, gradation correction processing, and pseudo-halftone processing.

The reader 44 is configured to include, for example, an image sensor, an optical system, a light source, and the like. The reader 44 captures an image of the sheet Sh, which is conveyed by the conveyor 37, from the upper surface side. The reader 44 is disposed in a line shape along the width direction of the sheet Sh. For example, the reader 44 captures an image of the sheet Sh at each position while the sheet Sh is being conveyed from the upstream side to the downstream side, thereby capturing an image of the sheet Sh in its entirety. Then, the images captured by the reader 44 at each position are superposed one on another, thereby generating a read image of the sheet Sh in its entirety. The reader 44 sends data according to the read image to the controller 41.

The reader 44 has a length exceeding the width of the sheet Sh, and is configured to be capable of capturing an image of a punch hole formed in the sheet Sh (that is, a binder sheet).

Note that, since the controller 41 adjusts the conveyance setting based on the read image acquired by the reader 44, the reader 44 is disposed at least on the upstream side of the image former 30 in the conveyance direction, more preferably, on the immediately downstream side of the sheet feed unit 2.

The conveyance sensor 45a and 45b detect an edge (leading edge) of the sheet Sh in the conveyance direction (also referred to as a sub-scanning direction). For example, photo sensors are used as the conveyance sensors 45a and 45b, and send a conveyance sensor signal indicating the passing timing of the sheet Sh to the controller 41.

In the present embodiment, the conveyance sensor 45a is disposed at a predetermined position before the sheet Sh reaches the registration roller pair 37b (for example, a position several centimeters upstream from the registration roller pair 37b). That is, the conveyance sensor 45a detects that the sheet Sh has reached the position of the registration roller pair 37b.

In addition, the conveyance sensor 45b is disposed at a predetermined position before the sheet Sh reaches the fixing section 36 (for example, a position several centimeters upstream of the fixing roller pair 36a of the fixing section 36). That is, the conveyance sensor 45b detects that the sheet Sh has reached the position of the fixing roller pair 36a of the fixing section 36.

Note that, hereinafter, the conveyance sensor 45a is also referred to as the “first conveyance sensor 45a”, and the conveyance sensor 45b is also referred to as the “second conveyance sensor 45b”.

The media sensor 46 is disposed in the conveyance route of the conveyor 37 upstream of the image former 30 and detects characteristics of the sheet Sh fed from the sheet feed unit 2.

The media sensor 46 detects the characteristics of the sheet Sh each time the sheet Sh is conveyed from the sheet feed tray 21 to the image former 30. The media sensor 46 detects, for example, sheet characteristics (that is, physical properties) such as the thickness, surface roughness, basis weight, and moisture content of the sheet Sh. The media sensor 46 is constituted by, for example, an LED that emits light toward the sheet Sh, a phototransistor that receives transmitted light or reflected light from the sheet Sh, and the like. Then, the media sensor 46 detects these sheet characteristics based on the transmittance and reflectance of the sheet Sh. The media sensor 46 sends data relating to the detected characteristics of the sheet Sh to the controller 41.

### Detailed configuration of the main body controller 41

In order to suppress the occurrence of a conveyance failure when printing is performed using a binder sheet, the controller 41 detects the arrangement aspect of a punch hole from a read image acquired by the reader 44 for each sheet Sh continuously fed from the sheet feed unit 2. Then, the controller 41 adjusts various settings when conveyance processing is performed on the sheet Sh based on the arrangement aspect of the punch hole in the sheet Sh, where the arrangement aspect is detected from the read image.

Note that, for more accurate conveyance control, the controller 41 may also detect the size of the punch hole in the sheet Sh in addition to the arrangement aspect of the punch hole in the sheet Sh from the read image. In addition, in a case where the controller 41 detects from a read image that no punch hole has been formed in the sheet Sh, the controller 41 performs conveyance setting as a normal sheet.

Specifically, the controller 41 adjusts the following setting items (1) to (5) based on the arrangement aspect of the punch hole in the sheet Sh:
(1) the setting range of a mask for erroneous detection prevention, which is set for a sensor signal from conveyance sensors 45a and 45b;
(2) the acceleration start timing of the conveyance speed of sheet Sh;
(3) the sheet loop amount formed by conveyance rollers 37a and 37b;
(4) the separation bias of the sheet separator 35a; and
(5) the air volume of the fixing separation fan 36b.

### (1) Adjustment of setting range of mask for erroneous detection prevention

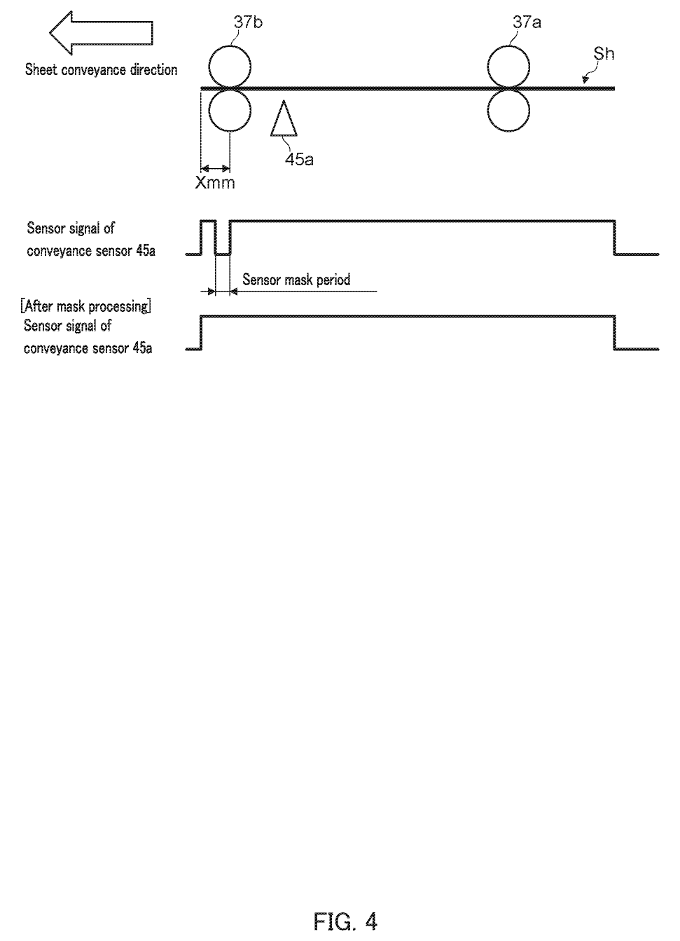

FIG. 4 is a diagram provided for describing processing of adjusting a setting range of a mask for erroneous detection prevention. FIG. 4 illustrates a time chart (upper stage) of a signal outputted by the first conveyance sensor 45a when the sheet Sh passes, and a time chart (lower stage) of the signal after mask processing is performed. Note that, FIG. 4 illustrates an example in which punch holes of the sheet Sh are disposed on the upstream side in the conveyance direction (see FIG. 2).

As described above, in the image forming apparatus 1, the conveyance sensors 45a and 45b for detecting that the sheet Sh has passed through the predetermined position are disposed in the conveyance route. For example, as illustrated in FIG. 4, the sensor signal of the conveyance sensor 45a and 45b outputs an on-signal during detection of the sheet Sh and outputs an off-signal during non-detection of the sheet Sh. Then, the controller 41 performs, based on the passing timing of the sheet Sh detected by the conveyance sensor 45a and 45b, synchronous control of the conveyance operation and the image forming operation or performs control such that the conveyance timing of the subsequent sheet Sh is adjusted.

However, in a case where a binder sheet is used, the sensor signal of the conveyance sensor 45a and sensor 45b is switched between on and off within a short time at the position of a punch hole. For this reason, the controller 41 may erroneously recognize a punch hole as the rear end position of the sheet Sh or as the leading end position of the subsequent sheet Sh. As a result, the controller 41 causes a conveyance failure such as a sheet jam.

From such a viewpoint, the controller 41 according to the present embodiment adjusts, based on the arrangement aspect of a punch hole in the sheet Sh, where the arrangement aspect is detected from a read image, the setting range of the mask to be set for the sensor signal of the conveyance sensors 45a and 45b that detect the sheet Sh in the conveyance route. Specifically, the controller 41 sets a mask in a range corresponding to a region in the sheet Sh, where the region is region which appears in the signal of the conveyance sensors 45a and 45b and in which a punch hole is present.

Thus, as illustrated at the lower stage of FIG. 4, the ON/OFF switching occurring at the position of a punch hole in the sensor signal of the conveyance sensors 45a and 45b is masked. That is, the controller 41 thus can prevent a situation in which a conveyance failure such as a sheet jam is caused due to a punch hole in a binder sheet.

### (2) Adjustment of Acceleration Start Timing of Sheet Sh

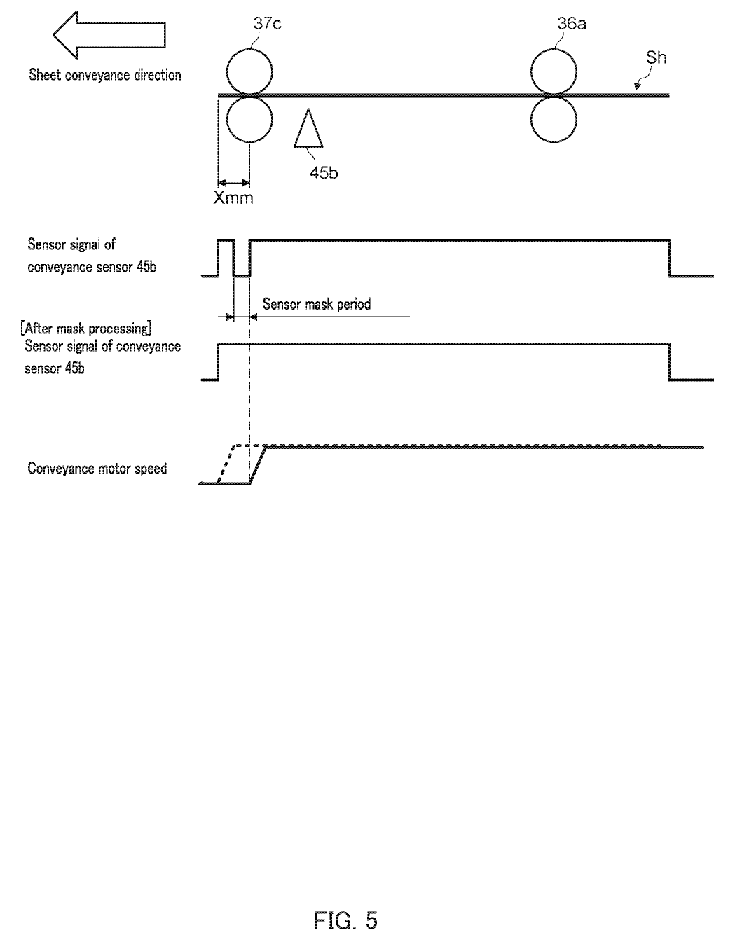

FIG. 5 is a diagram provided for describing processing of adjusting acceleration start timing of the sheet Sh. FIG. 5 illustrates a time chart (upper stage) of a sensor signal outputted by the second conveyance sensor 45b, a time chart (middle stage) of a sensor signal of the second conveyance sensor 45b after mask processing, and a time chart (lower stage) according to a conveyance motor speed by the variable speed roller pair 37c.

As described above, in the image forming apparatus 1, the processing of changing the conveyance speed of the sheet Sh is performed with the intention of gaining processing time at the post-processing section 50 and the fixing section 36. Specifically, for example, the controller 41 performs control such that, at the variable speed roller pair 37c, the conveyance speed of the sheet Sh is decreased while the sheet Sh is passing through the fixing section 36, and the conveyance speed of the sheet Sh is increased to a high speed after the sheet Sh has passed through the fixing section 36 and before the sheet Sh reaches the post-processing section. For example, in the printing on a normal sheet, the controller 41 performs control such that the conveyance speed of the sheet Shis accelerated by the variable speed roller pair 37a in response to the timing with which the leading end position of the sheet Sh has passed through the fixing roller pair 36c (see the dotted line at the lower stage of FIG. 5).

However, in the printing on a binder sheet, the sheet Sh may slip with respect to the variable speed roller pair 37c at the position of a punch hole in the sheet Sh. This is because a strong nip pressure is required at the variable speed roller pair 37c when the sheet Sh is accelerated. That is, in the case of a binder sheet, the contact area between the sheet Sh and the variable speed roller pair 37c becomes small at the position of a punch hole, and thus, there is a risk that the frictional force sufficient to apply the nip pressure from the variable speed roller pair 37c to the sheet Sh may not be obtained.

From such a viewpoint, the controller 41 according to the present embodiment adjusts, based on the arrangement aspect of a punch hole in the sheet Sh, the acceleration start timing of the conveyance speed of the sheet Sh in the conveyance route, where the arrangement aspect is detected from a read image. That is, the controller 41 adjusts the acceleration start timing such that acceleration of the conveyance speed of the sheet Sh is started when a punch hole has passed through the variable speed roller pair 37c in the conveyance route (see the solid line at the lower stage of FIG. 5).

Thus, it is possible to prevent a situation in which the sheet Sh slips with respect to the variable speed roller pair 37c at the position of a punch hole in the sheet Sh to cause a conveyance failure.

Note that, here, the variable-speed conveyance roller pair 37c has been described as an example of the conveyance roller pair that performs the variable-speed operation among the conveyance rollers 37. In addition, the image forming apparatus 1 may be provided with a variable speed roller pair or the like that accelerates the conveyance speed in the conveyance route used in double-sided printing. In such a case, the controller 41 may adjust the acceleration start timing in the same manner as the adjustment processing for the variable speed roller pair 37c.

### (3) Adjustment of sheet loop amount

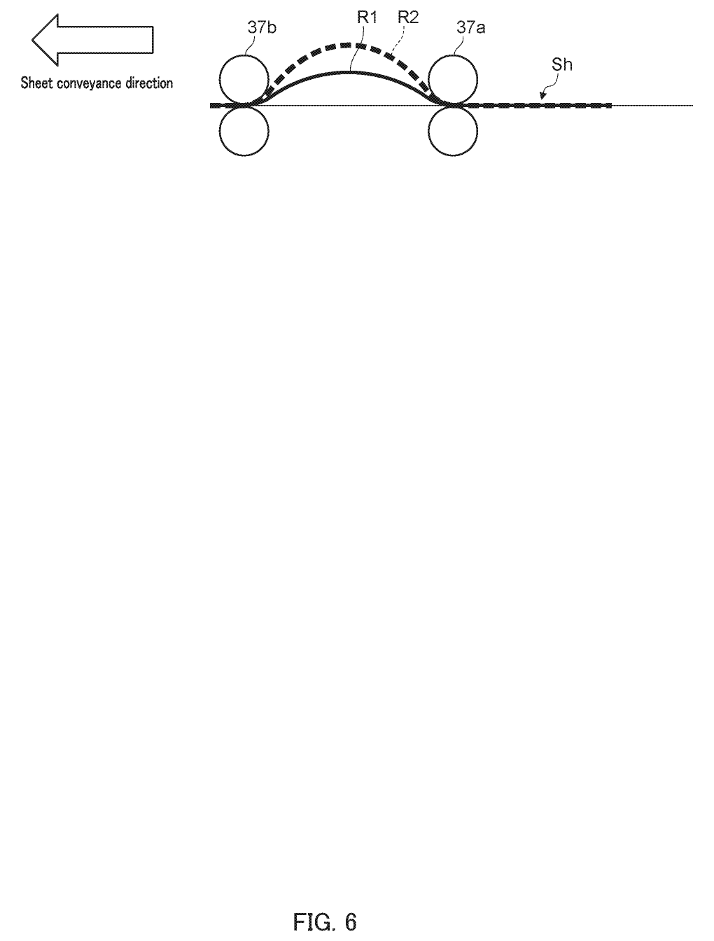

FIG. 6 is a diagram provided for describing processing of adjusting a sheet loop amount. FIG. 6 illustrates an aspect of a loop formed on the sheet Sh by the loop roller pair 37a and the registration roller pair 37b. In FIG. 6, R2 (the dotted line) indicates the sheet loop amount set for printing on a normal sheet, and R1 (the solid line) indicates the sheet loop amount set for printing on a binder sheet.

As described above, in order to perform the bend correction of the sheet Sh in the image forming apparatus 1, the controller 41 performs the operation of forming a loop in the sheet Sh at the positions of the registration roller pair 37b and the loop roller pair 37a during the conveyance operation of the sheet Sh. Specifically, the controller 41 temporarily stops the rotation of the registration roller pair 37b, and causes the leading edge of the sheet Sh to abut against the nip section formed by the registration roller pair 37b. In this state, the controller 41 rotationally drives the loop roller pair 37a on the upstream side to form a loop in the sheet Sh between the registration roller pair 37b and the loop roller pair 37a.

However, in a case where a punch hole is disposed on the leading end side of the sheet Sh, the stiffness of the sheet Sh is weak, and there is a risk that the sheet Sh will be crushed with the loop amount (R2 in FIG. 6) set for the sheet. From such a viewpoint, the controller 41 according to the present embodiment adjusts, based on the arrangement aspect of a punch hole in the sheet Sh, the sheet loop amount, where the arrangement aspect is detected from a read image. Specifically, in a case where a punch hole is present on the leading end side of the sheet Sh, the controller 41 decreases the sheet loop amount (R1 in FIG. 6) more than in a case where no punch hole is present on the leading end side of the sheet Sh.

Thus, it is possible to prevent a situation in which a conveyance failure such as a sheet jam occurs due to the sheet Sh being crushed when a loop is formed in the sheet Sh.

### (4) Adjustment of separation bias to be applied to the sheet separator 35a

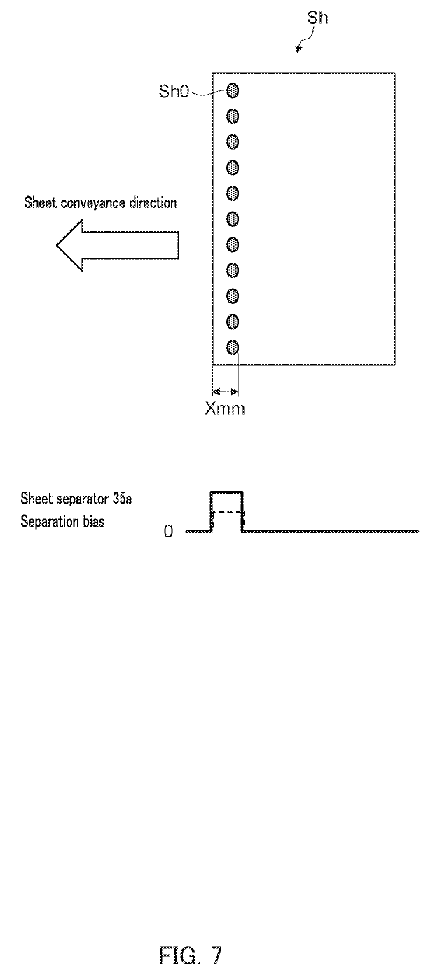

FIG. 7 is a diagram provided for describing processing of adjusting a separation bias to be applied to the sheet separator 35a. The lower stage of FIG. 7 illustrates a time chart of a separation bias to be applied to the sheet separator 35a when the sheet Sh passes through the sheet separator 35a.

As described above, in the image forming apparatus 1, after the toner image formed on the intermediate transfer belt 34 is transferred onto the sheet Sh, a separation bias having a polarity opposite to that of the transfer bias is applied to the sheet Sh at the sheet separator 35a. Thus, processing of separating the sheet Sh from the transfer roller of the secondary transfer section 35 is performed.

However, in a case where a punch hole is disposed on the leading end side of the sheet Sh, the curl generated at the leading end of the sheet Sh tends to increase, due to which the sheet Sh is easily wound around the transfer roller when the toner image is transferred. For this reason, the separation of the sheet Sh from the transfer roller is not smoothly performed with the normal separation bias (that is, the separation bias set for a normal sheet) (the dotted line at the lower stage of FIG. 7), which may cause a conveyance failure.

From such a viewpoint, the controller 41 according to the present embodiment adjusts, based on the arrangement aspect of a punch hole in the sheet Sh, the separation bias to be applied to the sheet separation portion 35a, where the arrangement aspect is detected from a read image. Specifically, in a case where a punch hole is present on the leading end side of the sheet Sh, the sheet separator 35a increases the separation bias to be applied to the leading end side of the sheet Sh (the solid line at the lower stage of FIG. 7).

Thus, it is possible to prevent a situation in which the leading end of the sheet Sh is wound around the transfer roller of the secondary transfer section 35 and a conveyance failure such as a sheet jam occurs.

Note that, here, as an example of the measures for preventing winding around the transfer roller of the secondary transfer section 35, the adjustment of the separation bias to be applied to the sheet separator 35a has been described. However, some models of image forming apparatus may not include the sheet separator 35a. In this case, as a variation, it is desirable to perform processing of adjusting a transfer bias to be applied to the transfer roller of the secondary transfer section 35.

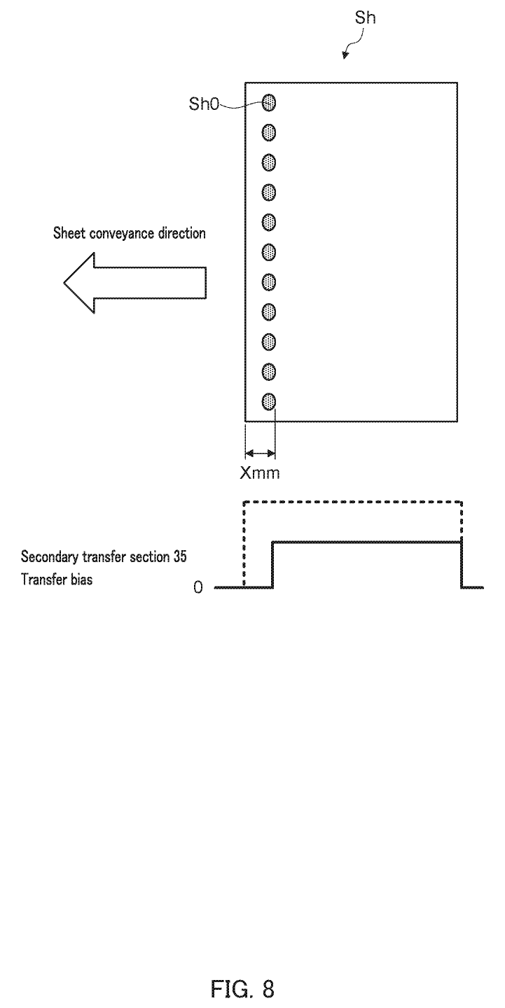

FIG. 8 is a diagram provided for describing processing of adjusting a transfer bias to be applied to the secondary transfer section 35. The lower stage of FIG. 8 illustrates a time chart of a transfer bias to be applied to the secondary transfer section 35 when the sheet Sh passes through the secondary transfer section 35.

In such a variation aspect, in a case where a punch hole is present on the leading edge side of the sheet Sh, the controller 41 reduces the transfer bias to be applied to the transfer roller of the secondary transfer section 35 at the position corresponding to the leading edge side of the sheet Sh (the solid line at the lower stage of FIG. 8) as compared with the normal case (the dotted line at the lower stage of FIG. 8).

In the same manner, even such a method makes it possible to prevent a situation in which the leading end of the sheet Sh is wound around the transfer roller of the secondary transfer section 35 and a conveyance failure such as a sheet jam occurs.

### (5) Adjustment of air volume of the fixing separation fan 36b

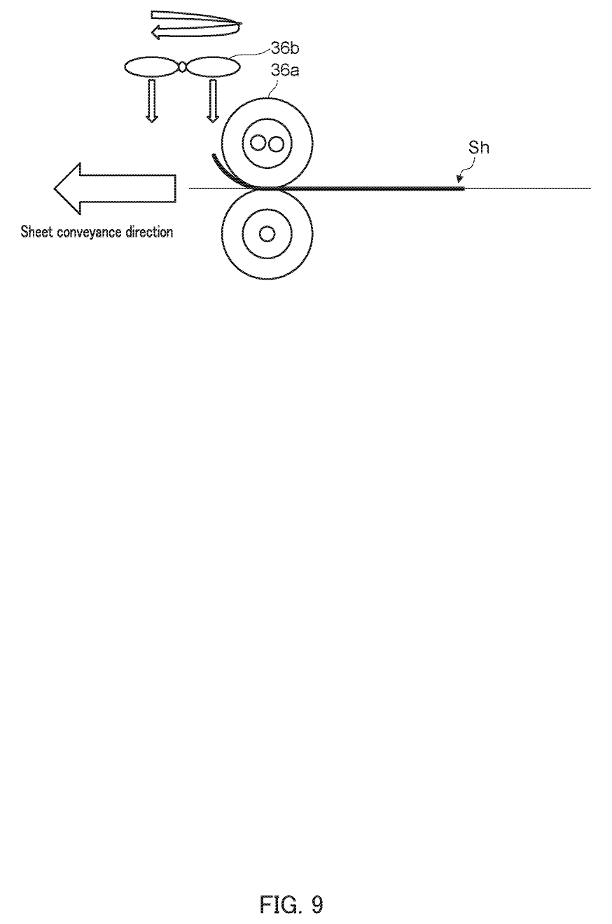

FIG. 9 is a diagram provided for describing processing of adjusting an air volume of the fixing separation fan 36b. FIG. 9 illustrates a separation aspect of the sheet Sh by the fixing separation fan.

As described above, in the fixing section 36 of the image forming apparatus 1, the air blown from the fixing separation fan 36b prevents the sheet Sh after toner fixing from adhering to and being wound around the fixing upper roller of the fixing roller pair 36a.

However, in a case where a punch hole is disposed on the leading end side of the sheet Sh, the curl generated at the leading end of the sheet Sh tends to increase, due to which the sheet Sh is likely to be wound around the upper fixing roller of the fixing roller pair 36a. For this reason, the separation of the sheet Sh from the upper fixing roller is not smoothly performed with the normal air blowing amount (that is, the air blowing amount set for a normal sheet), which may cause a conveyance failure.

From such a viewpoint, in a case where a punch hole is present on the leading end side in the sheet Sh, the controller 41 according to the present embodiment increases the air volume of the fixing separation fan 36b to prevent the sheet Sh from being wound around the upper fixing roller.

Thus, it is possible to prevent a situation in which the leading end of the sheet Sh is wound around the upper fixing roller and a conveyance failure such as a sheet jam occurs.

Operation flow of the controller 41

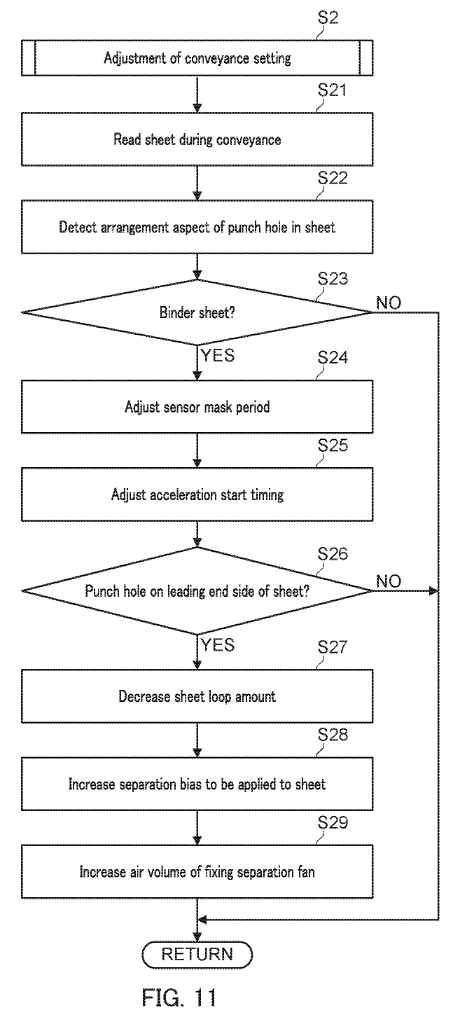

FIGS. 10 and 11 are flowcharts illustrating exemplary operations of the controller 41.

FIG. 10 is a flowchart illustrating processing of a main routine performed by the controller 41 when printing is executed.

The controller 41 executes the following processing according to job information set in a print job. Note that, in the processing from step S1 to step S5, the processing for each page is performed in order from the first page according to the job information.

In step S1, the controller 41 instructs the sheet feed controller 23 of the sheet feed unit 2 such that the sheet Sh set in the job information of the print job is fed.

In step S2, the controller 41 adjusts the conveyance setting so as to cause the conveyance setting to correspond to the sheet Sh fed from the sheet feed unit 2. Details of the processing in step S2 will be described later with reference to FIG. 11.

In step S3, the controller 41 controls the image former 30 such that image formation of a page as the printing target is performed on the sheet Sh during conveyance.

In step S4, the controller 41 controls the post-processing unit 5 such that post-processing is performed on the sheet Sh during conveyance. This post-processing is the above-described ring binder processing or the like.

In step S5, the controller 41 determines whether the processing that is being executed is processing on the last page. Then, in a case where the processing that is being executed is processing on the last page (S5: YES), the controller 41 ends the series of processing in the flowchart of FIG. 10. In a case where the processing that is being executed is not the processing on the last page (S5: NO), on the other hand, the controller 41 returns to step S1 and executes the processing on the next page.

FIG. 11 is a flowchart illustrating the adjustment processing of the conveyance setting (S2) in the main routine of FIG. 10.

In step S21, the controller 41 causes the reader 44 to execute the reading of the sheet Sh during conveyance.

In step S22, the controller 41 detects the arrangement aspect of a punch hole in the sheet Sh based on a read image acquired in step S21. The method of detecting the arrangement aspect of a punch hole from a read image may be any method known in the art. The controller 41 may detect the arrangement aspect of a punch hole in the sheet Sh from a read image by using, for example, image recognition processing known in the art, such as pattern matching.

In step S23, the controller 41 determines, based on the detection result of step S22, whether the sheet Sh during conveyance is a binder sheet. In a case where the sheet Sh during conveyance is a binder sheet (S23: YES), the controller 41 advances the processing to step S24. In a case where the sheet Sh during conveyance is not a binder sheet (S23: NO), on the other hand, the controller 41 ends the series of processing in the flowchart of FIG. 11 without performing any particular processing.

In step S24, the controller 41 adjusts, based on the arrangement aspect of the punch hole in the sheet Sh detected in step S22, the sensor mask period to be set for the sensor signal from the conveyance sensors 45a and 45b (see FIG. 4).

In step S25, the controller 41 adjusts, based on the arrangement aspect of the punch hole in the sheet Sh detected in step S22, the acceleration start timing of the sheet Sh at the variable speed roller pair 37c and the like (see FIG. 5).

In step S26, the controller 41 determines, based on the arrangement aspect of the punch hole in the sheet Sh detected in step S22, whether a punch hole is present on the leading end side of the sheet Sh. Here, in a case where a punch hole is present on the leading end side of the sheet Sh (S26: YES), the controller 41 advances the processing to step S27. In a case where no punch hole is present on the leading end side of the sheet Sh (S26: NO), on the other hand, the controller 41 ends the series of processing in the flowchart of FIG. 11.

In step S27, the controller 41 adjusts the operation timings of the registration roller pair 37a and the loop roller pair 37b in order to decrease the sheet loop amount formed by the loop roller pair 37a (see FIG. 6).

In step S28, the controller 41 increases a separation bias to be applied to the sheet Sh from the sheet separator 35a (see FIG. 7). Note that, at this time, together with the processing of adjusting the separation bias or instead of the processing of adjusting the separation bias, the controller 41 may perform setting to reduce a transfer bias to be applied to the transfer roller of the secondary transfer section 35 at the position corresponding to the leading edge side of the sheet Sh (see FIG. 8).

In step S29, the controller 41 increases the air volume of the fixing separation fan 36b (see FIG. 9).

After performing such adjustment processing (S2) of the conveyance setting, the controller 41 causes the sheet Sh to be conveyed to the downstream side of the image former 30 and the like, and executes the subsequent processing (S3 and S4).

In the image forming apparatus 1 according to the present embodiment, for each sheet Sh to be conveyed during a print job, various settings when the conveyance processing is performed on the sheet Sh are adjusted through the processing as described above in consideration of the possibility that the sheet Sh is a binder sheet. Thus, it is possible to suppress a conveyance failure which occurs due to the use of a binder sheet as the print target during a print job.

Note that, although a description has been omitted above, the optimum values of the sheet loop amount, the separation bias to be applied to the sheet Sh from the sheet separator 35a, and the like also depend on the characteristics of the sheet Sh (for example, the thickness, surface roughness, basis weight, and moisture content of the sheet Sh). Accordingly, when the controller 41 performs the processing of adjusting the conveyance setting (for example, S27 and S28), it is desirable to determine the setting values in consideration of both the arrangement aspect of the punch hole, where the arrangement aspect is detected from a read image, and the characteristics of the sheet Sh detected from the media sensor 44.

On the other hand, in the above-described flowchart, the aspect has been indicated in which the controller 41 adjusts every setting of the setting items (1) to (5) described above at the time of the adjustment processing of the conveyance setting (S2). However, it is not necessary to adjust all of the setting items (1) to (5) depending on the apparatus configuration of the image forming apparatus 1, and an aspect may be adopted in which the controller 41 adjusts only one or more of the setting items (1) to (5).

### Effects

As described above, in the present embodiment, an image forming apparatus applicable to a binder sheet has been disclosed which includes:

a sheet feeder that feeds a sheet;

a conveyor that conveys the sheet along a conveyance route;

an image former that is disposed in the conveyance route and forms an image on the sheet;

a reader that is disposed on an upstream side of the image former in a conveyance direction and captures an image of the sheet; and

a controller that adjusts, based on an arrangement aspect of a punch hole in the sheet, setting related to conveyance processing of the sheet, the arrangement aspect being detected from a read image.

The image forming apparatus of the present embodiment makes it possible to suppress the occurrence of a conveyance failure when printing is executed using a binder sheet. In particular, the image forming apparatus according to the present embodiment is useful in terms of being capable of executing a print job causing any conveyance failure even in a case where a binder sheet is used without performing sheet setting in advance.

Although embodiments of the present invention have been described and illustrated in detail, the disclosed embodiments are made for purpose of illustration and example only and not limitation. The scope of the present invention should be interpreted by terms of the appended claims.

### Industrial Applicability

The image forming apparatus according to the present invention makes it possible to suppress the occurrence of a conveyance failure even when printing is performed using a binder sheet.

What is claimed is:

1. An image forming apparatus applicable to a binder sheet, the image forming apparatus comprising:
a sheet feeder that feeds a sheet;
a conveyor that conveys the sheet along a conveyance route;
an image former that is disposed in the conveyance route and forms an image on the sheet;
a reader that is disposed on an upstream side of the image former in a conveyance direction and captures an image of the sheet; and
a hardware processor that adjusts, based on an arrangement aspect of a punch hole in the sheet, setting related to conveyance processing of the sheet, the arrangement aspect being detected from a read image.

2. The image forming apparatus according to claim 1, wherein
the hardware processor adjusts, based on the arrangement aspect of the punch hole in the sheet, a setting range of a mask to be set for a signal outputted by a conveyance sensor that detects the sheet in the conveyance route.

3. The image forming apparatus according to claim 2, wherein
the hardware processor sets the mask in a range corresponding to a region of the sheet where the punch hole is present, the region appearing in the signal outputted by the conveyance sensor and in which the punch hole is present.

4. The image forming apparatus according to claim 1, wherein
the hardware processor adjusts, based on the arrangement aspect of the punch hole in the sheet, an acceleration start timing of a conveyance speed of the sheet in the conveyance route.

5. The image forming apparatus according to claim 4, wherein
the hardware processor adjusts the acceleration start timing such that acceleration of the conveyance speed of the sheet is started when the punch hole has passed through a conveyance roller for a speed change in the conveyance route.

6. The image forming apparatus according to claim 1, wherein
the hardware processor adjusts, based on the arrangement aspect of the punch hole in the sheet, a sheet loop amount formed by a conveyance roller in the conveyance route.

7. The image forming apparatus according to claim 6, wherein
in a case where the punch hole is present on a leading end side of the sheet, the controller decreases the sheet loop amount more than in a case where the punch hole is not present on the leading end side of the sheet.

8. The image forming apparatus according to claim 1, wherein
the hardware processor adjusts, based on the arrangement aspect of the punch hole in the sheet, a transfer bias to be applied to a transfer roller of the image former or a separation bias to be applied to the sheet at a sheet separator provided immediately downstream of the transfer roller of the image former.

9. The image forming apparatus according to claim 8, wherein
in a case where the punch hole is present on the leading end side of the sheet, the hardware processor decreases the transfer bias to be applied at a position corresponding to a leading end side of the sheet more than in a case where the punch hole is not present on the leading end side of the sheet or increases the separation bias more than in a case where the punch hole is not present on the leading end side of the sheet.

10. The image forming apparatus according to claim 1, wherein
the hardware processor adjusts, based on the arrangement aspect of the punch hole in the sheet, an air volume of a fixing separation fan disposed on a downstream of a fixing roller in the conveyance route.

11. The image forming apparatus according to claim 10, wherein
the hardware processor increases the air volume of the fixing separation fan in a case where the punch hole is present on the leading end side of the sheet more than in a case where the punch hole is not present on the leading end side of the sheet.

12. A control method of an image forming apparatus applicable to a binder sheet, the control method comprising:
feeding a sheet;
conveying the sheet along a conveyance route;
capturing an image of the sheet to be conveyed;
forming an image on the sheet to be conveyed; and
adjusting, based on an arrangement aspect of a punch hole in the sheet, setting related to conveyance processing of the sheet, the arrangement aspect being detected from a read image.

13. A non-transitory computer-readable recording medium storing
a control program for an image forming apparatus applicable to a binder sheet, the control program causing a computer to execute:
feeding a sheet;
conveying the sheet along a conveyance route;
capturing an image of the sheet to be conveyed;
forming an image on the sheet to be conveyed; and
adjusting, based on an arrangement aspect of a punch hole in the sheet, setting related to conveyance processing of the sheet, the arrangement aspect being detected from a read image.
